(19) United States
(12) Patent Application Publication
(10) Pub. No.: US 2014/0360485 A1
(43) Pub. Date: Dec. 11, 2014

(54) MODIFIED STEAM-METHANE-REFORMATION TECHNIQUE FOR HYDROGEN PRODUCTION

(71) Applicant: Surendra SAXENA, Miami, FL (US)

(72) Inventor: Surendra SAXENA, Miami, FL (US)

(21) Appl. No.: 14/467,505

(22) Filed: Aug. 25, 2014

Related U.S. Application Data
(63) Continuation of application No. 13/161,747, filed on Jun. 16, 2011.
Application No. 13/161,747 is a continuation of application No. 12/552,898, filed on Sep. 2, 2009, now abandoned.

(51) Int. Cl. C01B 3/48; F24J 1/00; C01B 21/02; C01B 3/02; C01D 7/07; C01D 7/10

(52) U.S. Cl. CPC C01B 3/48; C01D 7/07; C01D 7/10; C01B 21/02; C01B 3/02; F24J 1/00; C01B 2203/0205; C01B 2203/025; C01B 2203/86; C01B 2203/0827; C01B 2203/84
USPC 126/263.01; 422/162; 423/650; 423/421; 423/422; 423/351

(57) ABSTRACT

A process of and system for sequestering carbon (CO₂) produced in coal and gas burning hydrogen production plants, resulting in the production of hydrogen at current market prices or less without carbon emission.

### CROSS REFERENCE TO RELATED APPLICATIONS

This patent application is a continuation of U.S. patent application Ser. No. 13/161,747, filed on Apr. 25, 2014; which is a continuation of U.S. patent application Ser. No. 12/552,898, filed on Sep. 9, 2009; which claims priority to International Application PCT/US2008/055586, filed Mar. 2, 2008; which is a non-provisional of U.S. provisional application 60/982,473, filed Oct. 25, 2007.

### STATEMENT REGARDING FEDERALLY SPONSORED RESEARCH OR DEVELOPMENT

No federal government funds were used in researching or developing this invention.

### NAMES OF PARTIES TO A JOINT RESEARCH AGREEMENT

Not applicable.

### SEQUENCE LISTING INCLUDED AND INCORPORATED BY REFERENCE HEREIN

Not applicable.

### BACKGROUND

1. Field of the Invention

The present invention relates to a system of processes for sequestering carbon in hydrogen manufacturing plants, which use the industrial method of steam-methane (coal)-reformation. This is achieved by balancing the masses of feedstock and energy such that the end result is hydrogen, sequestered or captured carbon dioxide and residual energy to be used in other applications. The use of this invention will provide cheap hydrogen with zero or highly reduced carbon emission.

2. Background of the Invention

The United States leads the world in per capita CO₂-emissions. In 2004, the total carbon release in North America was 1.82 billion tons. World-wide industrial nations were responsible for 3790 million metric tons of CO₂ (Kyoto-Related Fossil-fuel totals). Accordingly, there is an urgent need to develop innovative solutions to reduce the emissions from our automobiles and from our coal or gas burning power plants and hydrogen production plants.

Presently, steam methane reforming is the most common and the least expensive method of producing hydrogen. Coal can also be reformed to produce hydrogen through gasification. Compared to methods of hydrogen production using fossil fuels, methods that do not use fossil fuels and therefore do not emit CO₂ are either more expensive or are in the very early stages of development. Current industrial production of hydrogen generates several tons of carbon dioxide for each ton of hydrogen. Since the United States has more proven coal reserves than any other country, hydrogen production through a coal-based technology has the capacity to generate huge quantities of usable hydrogen gas. Unfortunately, effective and low cost carbon sequestration technology has not yet been developed to allow for a commercially viable coal-based hydrogen production system.

Hydrogen is widely regarded as the energy of the future, but the production of hydrogen for fuel, whether by direct combustion or in a fuel cell, itself requires energy. Thus, using hydrogen or any other material to produce energy cannot be environmentally clean and economically viable so long as such production emits substantial amounts of greenhouse gasses. Although hydrogen fuel production and use is being promoted by the United States government, for the foreseeable future, such production will continue to be dependent on the use of fossil fuels. Thus, new methods of carbon sequestration are needed to create an economically and environmentally viable system of producing hydrogen from fossil fuels.

Coal is used extensively in producing synthetic fuels. Use of coal in gasifiers is well established and hydrogen may be produced by the reaction: C+2H₂O=CO₂₊₂H₂. Gasifiers are operated between 500 to 1200° C., and use steam, oxygen and/or air and produce a mixture of CO₂, CO, SO₂, NOₓ, H₂, CH₄ and water. Treatment systems are available for SO₂ and NOₓ but CO₂ remains a problem. The CO produced can be further processed by the shift-gas reaction to produce H₂ with production of CO₂: CO+H₂O=CO₂+H₂.

The following is an extract from a report by National Academy of Engineering, Board on Energy and Environmental Systems and shows the importance of the present study:

“At the present time, global crude hydrogen production relies almost exclusively on processes that extract hydrogen from fossil fuel feedstock. It is not current practice to capture and store the by-product CO₂ that results from the production of hydrogen from these feed stocks. Consequently, more than 100 Mt C/yr are vented to the atmosphere as part of the global production of roughly 38 Mt of hydrogen per year.”

It would then appear that when coal is used in gasifiers or in hydrogen manufacturing-plants, CO₂ and CO are prominent among other gases released to atmosphere. The emission of such carbon compounds into the atmosphere not only harms the environment, but also constitutes a waste of resources, resulting in an economic loss to companies in the industry.

This invention will provide a clear economic incentive to sequester carbon (CO₂) without significantly affecting current modes of operations of gas- and coal-burning hydrogen power plants, while simultaneously lowering the cost of hydrogen production and eliminating any resulting emission of greenhouse gases.

### RELATED PATENTS

U.S. Pat. No. 7,132,090, D. Dziedzic, K. B. Gross, R. A. Gorski, J. T. Johnson—Sequestration of carbon dioxide.

US patent application 20030017088, W. Downs and H. Sarv—Method for simultaneous removal and sequestration of CO₂ in a highly efficient manner.

US patent application 20010022952, G. H. Rau and K. G. Caldeira—Method and apparatus for extracting and sequestration carbon dioxide.

U.S. Pat. No. 5,261,490, T. Ebinuma—Method for dumping and disposing of carbon dioxide gas and apparatus.

U.S. Pat. No. 6,667,171, D. J. Bayless, M. L. Vis-Morgan and G. G. Kremer—Enhanced practical photosynthetic CO₂ mitigation.

U.S. Pat. No. 6,598,407, O. R. West, C. Tsouris and L. Liang—Method and apparatus for efficient injection of CO₂ in ocean.

U.S. Pat. No. 5,562,891, D. F. Spencer and W. J. North—Method for the production of carbon dioxide hydrates.

U.S. Pat. No. 5,293,751, A. Koetsu—Method and system for throwing carbon dioxide into the deep sea.

U.S. Pat. No. 6,270,731, S. Kato, H. Oshima and M. Oota—Carbon dioxide fixation system.

U.S. Pat. No. 5,767,165, M. Steinberg and Y. Dong—Method for converting natural gas and carbon monoxide to methanol and reducing CO₂ emission.

U.S. Pat. No. 6,987,134, R. Gagnon—How to convert carbon dioxide into synthetic hydrocarbon through a process of catalytic hydrogenation called CO₂ hydrocarbonation.

U.S. Pat. No. 7,282,189 B2 Zauderer—Production of hydrogen and removal and sequestration of carbon dioxide from coal-fired furnaces and coal burners.

US 2006/0048517 A1 Fradette et al.—Process and a plant for recycling carbon dioxide emissions from power plants into useful carbonated species.

US 2004/0126293 Geerlings et al.—Process for removal of carbon dioxide from flue gases.

U.S. Pat. No. 6,669,917 B2 Lyon—Process for converting coal into fuel cell quality hydrogen and sequestration-ready carbon dioxide.

U.S. Pat. No. 7,083,658 B2 Andrus Jr. et al.—Hot solids gasifier with CO₂ removal and hydrogen production.

US 2005/0163706 A1 Reichman et al.—Production of hydrogen via a base-facilitated reaction of carbon monoxide at low temperatures.

US 2006/0185985 A1 Jones—Removing, carbon dioxide from waste streams through co-generation of carbonate and/or bicarbonate minerals.

### BRIEF SUMMARY OF THE INVENTION

The present invention provides a process to sequester carbon from the fuel burner exhaust gases in industrial hydrogen production plants.

In a preferred embodiment of the present invention, there is provided process to sequester carbon from the fuel burner exhaust gases in industrial hydrogen production plants comprising the steps of: (a) burning a mixture of an oxidant and fuel; (b) generating flue gas and products of combustion; (c) streaming the generated flue gas and the products of combustion into a first reactor; (d) determining an amount of thermal energy needed from the fuel to produce hydrogen in a balanced steam-fuel-reformation reaction; (e) adding the determined amount of fuel and water to produce hydrogen; (f) passing all products of the reaction to a second reactor; and (g) combining the products with sodium hydroxide to react at a low temperature to form sodium carbonate.

In another embodiment, the process of paragraph 33, further comprising wherein the oxidant of step (a) is selected from atmospheric air or oxygen.

In another embodiment, the process of paragraph 33, further comprising wherein the fuel of step (a) is coal or natural gas.

In another embodiment, the process of paragraph 33, further comprising wherein the flue gas and products of combustion of step (b) is mainly carbon dioxide.

In another embodiment, the process of paragraph 33, further comprising wherein the sodium hydroxide of step (g) is adjusted to react with components of gas comprised of sulfur dioxide, nitric oxide, or both, to form removable solids.

In another embodiment, the process of paragraph 33, further comprising wherein the reaction of step (e) comprises a direct conversion of NaOH to Na₂CO₃.

In another embodiment, the process of paragraph 33, further comprising wherein further sequestration is achieved by extending the reaction of step (e) by further reacting Na₂CO₃ with water and CO₂.

In another embodiment, the process of paragraph 33, further comprising wherein, fuel is continuously feed to the reactions throughout the process.

In another embodiment, the process of paragraph 33, further comprising the step of adding water when combining the products with sodium hydroxide to produce sodium bicarbonate.

In another embodiment, the process of paragraph 33, further comprising: step (h) crystallizing impurities by combining such impurities with soda and then removing them.

In another embodiment, the process of paragraph 42, further comprising wherein step (h) of recrystallizing the soda is accomplished through combination with an aqueous solution.

In another embodiment, further comprising wherein reaction products selected from sodium carbonate, sodium bicarbonate, hydrogen, nitrogen, or any combination thereof, are sold.

In another embodiment, energy produced from the combining the products of the reaction with sodium hydroxide are sold.

In another preferred embodiment, a process to sequester carbon from the fuel burner exhaust gases in industrial hydrogen production plants comprising the steps of: (a) burning a mixture of atmospheric air or oxygen and natural gas or coal; (b) generating flue gas and products of combustion, comprising mainly carbon dioxide; (c) streaming the generated flue gas and the products of combustion into a first reactor; (d) determining an amount of thermal energy needed from the fuel to produce hydrogen in a balanced steam-fuel-reformation reaction; (e) adding the determined amount of fuel and water to produce hydrogen, comprising a direct conversion of NaOH to Na₂CO₃; (f) passing all products of the reaction to a second reactor; (g) combining the products with sodium hydroxide to react at a low temperature to form sodium carbonate; and (h) crystallizing impurities by combining such impurities with soda and then removing them.

In another embodiment, a system is provided for sequestering carbon from the fuel burner exhaust gases in industrial hydrogen production plants, comprising the steps of: (a) a burner for combusting a mixture of an oxidant and fuel and generating flue gas and products of combustion; (b) a first feeder to stream the generated flue gas and the products of combustion into a first reactor; (c) wherein the first feeder is in communication with the burner to produce hydrogen in a balanced steam-fuel-reformation reaction; (d) a second feeder to pass all products of the reaction to a second reactor; and (e) wherein the second reactor is for combining the first reactor products with sodium hydroxide to form sodium carbonate.

### BRIEF DESCRIPTION OF THE DRAWINGS

FIG. 1 shows the steam-methane-reformation modified to produce hydrogen and carbonate from natural gas. An amount of methane is burnt in air to provide heat to the first reactor which produces an amount of hydrogen and CO from a mixture of all gases of the burner (CO₂ and steam) and the additional methane pumped into the reactor. The reaction will take place with an optimum temperature around 850-900° C. with some added pressure, such pressure to be determined by the space consideration (the reaction is not affected significantly by pressure in 1 to 10 atm range). The gases are then vented into a second steel reactor with ceramic lining where they are allowed to react with sodium hydroxide at 400° C. Several impurities such as sulfur and mercury will form solids with sodium carbonate and may be removed later by well known treatment methods. Any nitrous oxides will dissociate at this temperature. Heat must be recovered from this reactor to make the entire process run without any external energy. Nitrogen and hydrogen may be used directly for ammonia synthesis or the gases can be separated using membranes for selling. The soda is recrystallized through an aqueous process. All values are in moles.

FIG. 2 shows the method of balancing the heats of the two reactions, the hydrogen producing reaction and the coal burning. The mass has to be adjusted such that the energy from burning coal is similar to the energy required for the coal-water reaction. As an example in FIG. 2, 1.5 moles of carbon is burned to obtain 590 kJ of energy sufficient for the carbon-water reaction. All CO₂ produced is added to the reactor for conversion to CO and subsequently for carbonation.

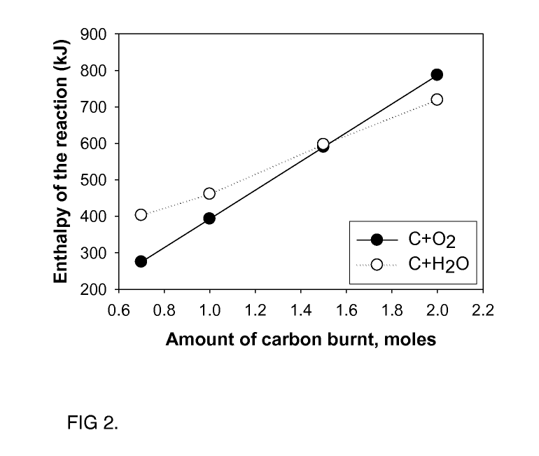

FIG. 3 shows the steam-coal gasification process modified to produce hydrogen and carbonate. An amount of coal is burnt in air to provide heat to the first reactor which produces an amount of hydrogen and CO from a mixture of all gases of the burner (CO₂ and steam) pumped into the reactor and coal is added. The reaction will take place with an optimum temperature around 900-950° C. with some pressure (to be determined by the space consideration; the reaction is not affected significantly by pressure in 1 to 10 atm range). The gases are then fed into a second steel reactor with ceramic lining where they are allowed to react with sodium hydroxide at 425° C. Several impurities such as sulfur and mercury will form solids with sodium carbonate and may be removed later by well known treatment methods. Any nitrous oxides will dissociate at this temperature. Heat must be recovered from this reactor to make the entire process run without any external energy. Nitrogen and hydrogen may be used directly for ammonia synthesis or the gases can be separated using membranes for selling. The soda is recrystallized through an aqueous process. All values are in moles.

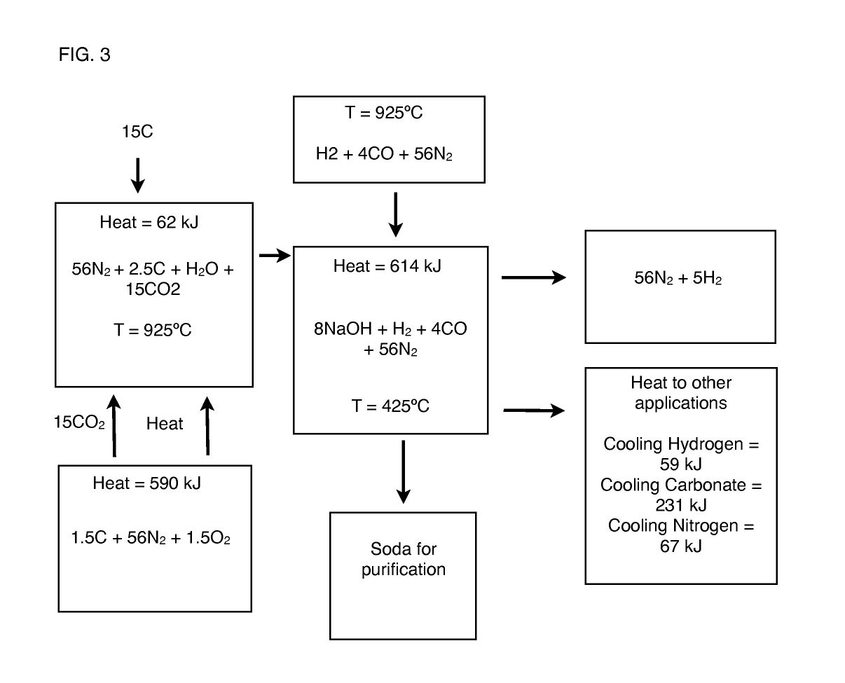

FIG. 4 shows hydrogen generation in 2NaOH (c)+CO (g)=Na₂CO₃ (c)+H₂ (g) reaction studied at different temperatures. N₂ carrier gas flow rate 50 mL/min. c. Hydrogen flow rates in the CO+2NaOH reaction measured at different temperatures and CO flow rate of 20 mL/min and N₂ flow rate of 50 mL/min. Hydrogen flow rate vs. time dependence at 300° C. is characterized by about a three hour initialization period. However, after the initialization period the reaction accelerated. It may be due to the formation on the initial stages of the reaction of some intermediates, which themselves or together with sodium hydroxide melt below 300° C. The presence of a liquid phase promotes the reaction. Sodium hydroxide and sodium carbonate have melting points 323 and 852° C., respectively. The rate is specific to the experimental setup and should be much faster in the industrial reactor.

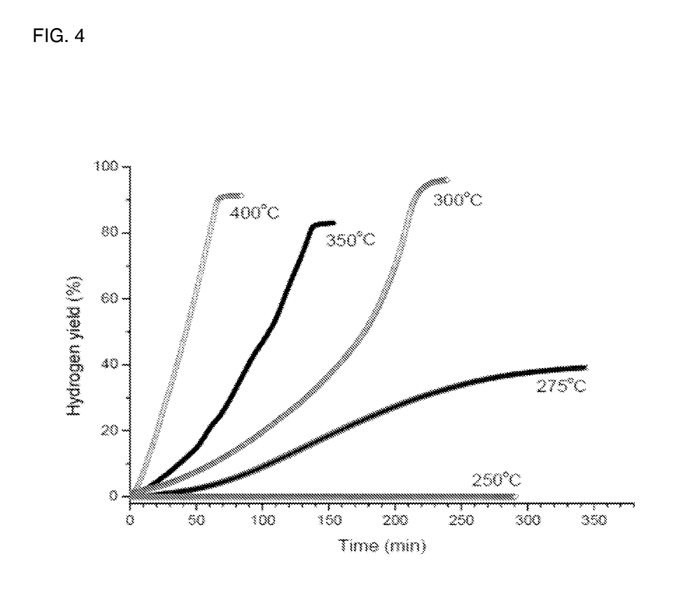

### DETAILED DESCRIPTION OF THE INVENTION

The present invention provides a novel method of sequestering carbon in fossil fuel burning hydrogen production plants; the novelty lies in the fact that gases produced in a coal/gas-burning fuel burner will not be released to the atmosphere but directed to a reactor (e.g. a modified SMR plant) for further conversion to CO along with the hydrogen production reaction. The amount of fuel to be burnt is adjusted to yield an appropriate amount of energy for the coal-water reaction.

The invention addresses carbon sequestration in hydrogen manufacturing plants that use fossil fuel. The chemical processes sequester carbon gases (thus preventing them from escaping to the atmosphere) and generate hydrogen with zero carbon emission. This invention would use coal or natural gas to produce hydrogen with carbon sequestration.

This invention operates by keeping all emissions (including that which provides the energy by burning coal or gas) together until the end stage of the series of reactions. A method of the invention comprises the steps of burning an appropriate amount of coal or gas in oxygen or air (mixture of O₂ and N₂) to generate enough energy for the gas-shift reaction (standard industrial method) in a reactor which produces hydrogen (H₂) and carbon monoxide (CO) and then passing all the gases (H₂, CO and N₂) at high temperature to the second reactor in which the CO is fixed in carbonate, then passing all the remaining gases consisting of H₂ (and N₂, if air is used); production of a solid sellable carbonate is via the second reaction, which solid is purified by recrystallization. Additionally, little or no additional energy should be needed to run the reactors because the heat produced both from burning coal or gas and from carbonation far exceeds the required heat for the partial gas-shift reaction, assuming proper engineering management of the endothermic (heat requiring) and exothermic (heat producing) reactions.

The reactant and product masses are balanced in such a way that the net result is production of soda, hydrogen and energy as useful and salable products. This invention does not require the production of new sodium hydroxide for with hydrogen, but uses the already produced solid as a byproduct of chlorine production. This procedure does not lead to any additional release of carbon dioxide from the manufacturing of sodium hydroxide but actually mitigates the carbon emission related to the production of sodium hydroxide.

The reactors provide not only hydrogen and carbonate but may also provide relatively pure nitrogen. The mixed gases (N₂+H₂) can be directly used in ammonia plants or the gases can be separated for selling as needed. Most contaminants occurring in coal or gas are removed in the final reactor as solids. Then, the carbonate may be recrystallized for purification.

The invention relies on processes described below.

CO₂ Sequestration and Hydrogran Production—Coal-Based Reactions

Carbon is used in discussing the chemical reactions below. It is understood that when carbon is replaced by coal, the reactions will change depending on the composition of coal. Similarly, oxygen will be replaced by air in the industrial process. For these calculations we have assumed that the heat transfer is 100% which will not be possible in the industrial system.

1.5C+1.5O₂=1.5CO₂ΔH=−590 kJ (25 C) (1)

2.5C+1.5CO₂+H₂O=4CO+H₂ΔH=+597 kJ (1027 C) (2)

4CO+H₂+8NaOH=4Na₂CO₃+5H₂ΔH=−802 kJ (227 C) (3)

5H₂ (227 C)→5H₂ (25 C)ΔH=−29 kJ

4Na₂CO₃ (227 C)→4Na₂CO₃ (25 C)ΔH=−101 kJ

Reaction (1) is to burn coal to generate enough heat to carry out reaction (3) which is a combination of the reactions (1) and (2):

C+H₂O=CO+H₂

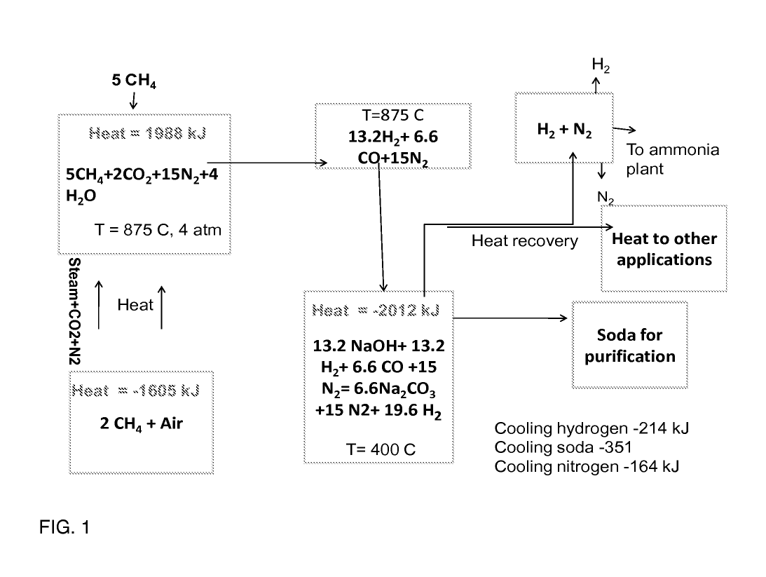

which in turn is part of the coal gasification process. The enthalpies of the reactions are plotted in FIG. 1 and show that by burning about 1.5 moles of coal enough heat is produced to convert all CO₂ into CO which includes the CO₂ emitted in reaction (1).

Environmental Significance

We emphasize that all energy is based on carbon (coal) and all CO₂ is locked into a carbonate which can be used in industry and for many applications sodium hydroxide can be replaced by it.

The process helps the environment in two ways. First, it reduces some of the CO₂ that has been released in the manufacturing of the sodium hydroxide. Second, the use of hydrogen produced without any carbon emission further mitigates the atmospheric CO₂. This statement is subject to the conditions that no new sodium hydroxide be produced to achieve that and the soda must be used in low-temperature industry without the dissociation of the carbonate. Sodium hydroxide must be a byproduct of the manufacturing process driven by the demand of chlorine.

Use of Air Instead of Oxygen for Coal-Based Reactions

The oxygen in the reactions above may be replaced by air as follows:

1.5C+1.5O₂+5.6N₂=1.5CO₂+5.6N₂ΔH=−590 kJ (25 C) (1b)

Reaction (1b) is to burn coal to generate enough heat to carry out reaction (3b) which is a combination of the reactions (1b) and (2b):

C+H₂O=CO+H₂ (2b)

Burning 18 tons of coal will produce 590 MJ of heat and 66 tons of CO₂; all the CO₂ is passed to the next reactor.

2.5C+1.5CO₂+H₂O+5.6N₂=4CO+H₂+5.6N₂ΔH=+662 kJ (925 C) (3b)

In this reactor, we have CO₂ from the previous step and addition of 30 tons of coal and 18 tons of water, which absorbs all the heat generated in the previous step and produces 112 tons of CO and 2 tons of hydrogen, which is led to the second reactor for the carbonation reaction.

4CO+H₂+5.6N₂+8NaOH=4Na₂CO₃+5H₂+5.6N₂ΔH=−614 kJ (425 C) (4b)

The reactor uses 320 tons of caustic soda. The carbonation reaction is exothermic, produces 614 MJ of heat at 614 C, and 424 tons of soda and 10 tons of hydrogen. For each ton of hydrogen, we need 32 tons of caustic soda producing 42.4 tons of soda.

Further heat recovery may be possible by cooling the gases to room temperature as follows:

5H₂ (425 C)→5H₂ (25 C)ΔH=−58.5 kJ

4Na₂CO₃ (425 C)→4Na₂CO₃ (25 C)ΔH=−231 kJ

5.6N₂ (425 C)→5.6N₂ (25 C)ΔH=−66.6 kJ

CO₂ Sequestration and Hydrogran Production—Natural Gas-Based Reactions

Maximum hydrogen is produced if natural gas is used instead of coal. For these calculations it is assumed that the heat transfer is 100% which will not be possible in the industrial system.

2CH₄+4O₂=2CO₂+4H₂OΔH=−1804 kJ (25 C) (5)

Reaction (5) burns gas to generate heat sufficient to carry out reaction (7), which is a combination of the reactions (5) and (6):

CH₄+H₂O=CO+3H₂ (6)

Burning 32 tons of gas will produce 1804 MJ of heat and 88 tons of CO₂ and 72 tons of steam; all the CO₂ and steam is passed to the next reactor.

5CH₄+4H₂O+2CO₂=6.6CO+13.2H₂ΔH=+1786 kJ (875 C) (7)

In this reactor, CO₂ and water from the previous step and are mixed with 80 tons of gas, which absorbs all the heat generated in the previous step and produces 185 tons of CO and 26.4 tons of hydrogen, which is fed to the second reactor for the carbonation reaction.

6.6CO+13.2H₂+13.2NaOH=6.6Na₂CO₃+19.8H₂ΔH=−1260 kJ (227 C) (8)

The reactor uses 528 tons of caustic soda. The carbonation reaction is exothermic, produces 1260 MJ of heat at 227 C, and 700 tons of soda and 40 tons of hydrogen; for each ton of hydrogen, we need 13 tons of caustic soda producing 17 tons of soda.

Further heat recovery may be possible by cooling the gases to room temperature as follows:

| | | |
|---|---|---|
| 19.8 H₂ (227 C.) | 19.8 H₂ (25 C.) | ΔH = −144 kJ |
| 6.6 Na₂CO₃ (227 C.) | 5 Na₂CO₃ (25) | ΔH = −214 kJ |

Environmental Significance

We emphasize that all energy is based on gas (methane) and all CO₂ is locked into a carbonate which can be used in industry and for many applications sodium hydroxide can be replaced by it.

The process helps the environment in two ways. First, it reduces some of the CO₂ that has been released in the manufacturing of the sodium hydroxide. Second, the use of hydrogen produced without any carbon emission further mitigates the atmospheric CO₂. This statement is subject to the conditions that no new sodium hydroxide be produced to achieve that and second the soda must be used in low-temperature industry without the dissociation of the carbonate. Sodium hydroxide must be a byproduct of the manufacturing process driven by the demand of chlorine.

Use of Air Instead of Oxygen for Natural Gas-Based Reactions

If air is used instead of oxygen, the energies needed are modified as shown below:

2CH₄+4O₂+14.85N₂=2CO₂+4H₂O+14.85N₂ΔH=−1605 kJ (25 C) (5b)

5CH₄+4H₂O+2CO₂+14.85N₂=6.6CO+13.2H₂ΔH=+1988 kJ (875 C) (6b)

6.6CO+13.2H₂+13.2NaOH+14.85N₂=6.6Na₂CO₃+19.8H₂ΔH=−1283 kJ (400 C) (7b)

19.8H₂ (400 C)→19.8H₂ (25 C)ΔH=−214 kJ

6.6Na₂CO₃ (400 C)→5Na₂CO₃(25)ΔH=−351 kJ

14.85N₂ (400 C)→14.85N₂ (25 C))ΔH=−164 kJ

Treatment of Na₂CO₃ and Additional Carbon Sequestration

The excess carbonate can be further used to sequester additional CO₂ according to the reaction:

Na₂CO₃+CO₂+H₂O=2NaHCO₃

This reaction takes place at 25° C. and does not require heating.

Experimental Data

Experiments were conducted to verify the theoretical predictions for the reactions using an in-house method involving measurement of evolving hydrogen by break-down laser spectroscopy. The reaction between CO, sodium hydroxide (anhydrous sodium hydroxide, supplied by Alfa Aesar (97%)) and water was carried out in a gas-flow system. Sodium hydroxide was dissolved using a minimal amount of distilled water in an alumina boat and then activated carbon was immersed into this solution. The alumina crucible was put in the quartz tube.

Catalysis of the reactions was not employed in the conducted experiments, but if needed can be used. A high production rate would result if continuous flow processes form the hydrogen. As envisaged here, the equilibrium calculations are for a closed system with a complete conversion of fixed ratio of reactants and production of the carbonate and hydrogen. Catalysis and partial conversion of the reactants will affect the costs.

Cost Analysis

The following analysis is provided as a guide to understand the possibilities. It lacks the details on engineering and the heat management for which an approximate cost is proposed. The price of the reactant (NaOH) and the products (soda and hydrogen) are the latest average prices.

If air is used, we will have to use a hydrogen membrane to separate nitrogen from hydrogen. If oxygen is to be used, the cost of a separation unit will become part of the capital cost.

Impurities in Coal and Other Exhaust Gases

The invention addresses principally the sequestration of carbon and production of hydrogen. The question of clean air involves minor and trace components of natural fossil-fuels (e.g. sulfur, mercury, nitrous oxides, etc.).

Industrial Adjustments

The mass and heat flow for production of a ton of hydrogen at 4 atm using natural gas:

Except for the burner reaction, all other reactions are at 4 atm and may therefore require more methane than the reactions at 1 atm.

Burner

To produce a ton of hydrogen each hour:

Feed: 808 kg of methane in air (13.7 tons consisting of 3.2 tons of oxygen and 10.5 tons of nitrogen)

Heat generated: −11148 kWh.

The products: 1.82 tons of water+2.222 tons of CO₂+10.5 tons of N₂.

The above mixture will be fed to the first reactor for the gas-water reaction.

First Reactor

The composition of the material in this reactor is the gases from the burner to which methane is added for reformation reaction.

Feed: 2.02 tons of CH₄+1.82 tons of water+2.222 tons of CO₂+10.5 tons of N₂.

The products: 4.7 tons of CO+0.667 tons of H2+10.5 tons of N2

The total heat required: 13821 kWh.

Temperature=875° C.

Pressure=4 atm; volume=2.1052e7 dm³

Second (Carbonation) Reactor

The product of the first reactor are combined with sodium hydroxide.

Feed: 4.7 tons CO+0.667 tons H₂+10.5 tons N₂+13.334 NaOH

Product: 17.7 tons soda+1 ton H₂+10.5 tons N₂

The total heat generated: 16653 kWh

Temperature=400° C.

Pressure=4 atm; volume=1.3787E7 dm³

The mass and heat flow for production of a ton of hydrogen at 4 atm using coal

Burner

To produce a ton of hydrogen each hour, we must burn 1.8 tons of coal in air (20.5 tons consisting of 4.8 tons of oxygen and 15.7 tons of nitrogen).

Heat generated: −16383 kWh.

The products: 1.8 tons of water+6.6 tons of CO₂+15.7 tons of N₂

The above mixture will be fed to the first reactor for the coal-water reaction.

First Reactor

The composition of the material in this reactor is the gases from the burner to which we add coal for the coal-water reaction.

Feed: 3 tons of C+1.8 tons of water+6.6 tons of CO₂+15.7 tons of N₂

The products: 11.2 tons of CO+0.2 tons of H_{2+15.7} tons of N₂

The total heat required: 19310 kWh

Temperature=1025° C.

Pressure=4 atm; volume=2.8142E7 dm³

Second (Carbonation) Reactor

The product of the first reactor are combined with sodium hydroxide.

Feed: 11.2 tons CO+0.2 tons H2+15.7 tons N2+32 tons NaOH

Product: 42.4 soda+1H2+15.7N₂

The total heat generated: 17384 kWh

Temperature=450° C.

Pressure=4 atm; volume=1.5627E7 dm³

Coal Replaces Carbon

The heating value of most coal (bituminous to anthracite) lies in the range of 28 to 36 kJ per gram. Our thermodynamic value is 32.7 kJ.

Other Volatiles and Contaminants in Coal and Natural Gas

Sodium carbonate is a good absorbent for many of the contaminants. For example SO₂ will react as follows:

Na₂CO₃+SO₂=Na₂SO₄+0.5CO₂+0.5C

In presence of SO₂, all Hg is either HgS or Hg₂SO₄. Both will precipitate as solids and are heavy solids easily separated during recrystallization of Na₂CO₃.

Electrostatic precipitators (ESP's), wet or dry, can capture particulates like sorbents, fly ash, or soot, in a wide range of temperatures. These devices have been adapted to “ionic” household air cleaners.

Nitrogen oxides (NOx) occur in all fossil fuel combustion, through oxidation of atmospheric nitrogen (N₂) and also from organic nitrogen fuel content, and flue gas NO concentrations are enhanced by high combustion chamber temperatures. In the last reactor, the reactions at 400° C. preclude the formation of any of these oxides. If there is a need for any for further purification, a series of scrubbers to get a purified gas can be added on to the reactor system as would be known by a person with ordinary skill in the art at the time of filing.

Finally if there are any unreacted residual gases (mainly CO), it will have to be removed by further pass through the carbonate reaction.

TABLE 1
Model of Price Variation and the Effect on the Price of Carbon
Sequestration in a Coal-based Plant

| | | Tons | | |
|---|---|---|---|---|
| | | used/ | | |
| | Price $/ | produced/ | | |
| Material | ton | hr | Expenses | Income $ |
| Water | 10 | 1.8 | 18 | |
| C | 60 | 4.8 | 288 | |
| Reactant | 300 | 32 | 9,600 | |
| solid | | | | |
| Product solid | 300 | 42.4 | | 12,720 |
| H₂ | 2000 | 1 | | 2,000 |
| N₂ | | 15.7 | | |
| Energy | | | 0 | |
| Total | | | 9906 | 14,720 |

| | | | |
|---|---|---|---|
| Income/hr, $ | | | 4,814 |
| Annual profit $ | | | 42,170,640 |
| CO₂ plant/yr | 0 | 0 | 0 |
| CO₂ by use of H₂ | 32412/yr | 0 | |
| Cleaning, | | 6,250,000 | 35,920,640 |
| maintenance, | | | |
| labor and misc, | | | |
| annual | | | |
| Capital $ | | (28,500,000) | |
| Time to recover | | | <1 yr |
| Capital, yrs | | | |

TABLE 2
Model of Price Variation and the Effect on the Price of Hydrogen from
Methane/Natural Gas

| | | Tons | | |
|---|---|---|---|---|
| | | used/ | | |
| | Price $/ | produced/ | | Income |
| Material | ton | hr | Expenses | $ |
| Gas | 300 | 2.83 | 850 | |
| Reactant | 300 | 13.33 | 4000 | |
| solid | | | | |
| Product solid | 300 | 17.7 | | 5310 |
| H₂ | 2000 | 1 | | 2,000 |
| N₂ | | 10.5 | | |
| Energy | | | 0 | |
| Total | | | 4850 | 7,310 |

| | | | |
|---|---|---|---|
| Income/hr, $ | | | 2,460 |
| Annual profit $ | | | 21,549,670 |
| CO₂ plant/yr | 0 | 0 | 0 |
| CO₂ by use of H₂ | 32412/yr | 0 | |
| Cleaning, | | 4,250,000 | 17,299,600 |
| maintenance, | | | |
| labor and | | | |
| misc, annual | | | |
| Capital $ | | (21,500,000) | |
| Time to | | | 1 yr+ |
| recover Capital, | | | |
| yrs | | | |

### RELATED REFERENCES

Probstein, R. F. and Hicks, R. E. Synthetic fuels, Dover, N.Y., 2006.
Gupta, H.; Mahesh, I.; Bartev, S., Fan, L. S. Enhanced Hydrogen Production Integrated with CO₂ Separation in a Single-Stage Reactor; DOE Contract No: DE-FC26-03NT41853, Department of Chemical and Biomolecular Engineering, Ohio State University: Columbus, Ohio, 2004.
Ziock, H-J.; Lackner, K. S.; Harrison, D. P. Zero Emission Coal Power, a New Concept. Proceedings of the First National Conference on Carbon Sequestration, Washington, D.C., May 15-17, 2001.
Rizeq, G.; West, J.; Frydman, A.; Subia, R.; Kumar, R.; Zamansky, V.; Loreth, H.; Stonawski, L.; Wiltowski, T.; Hippo, E.; Lalvani, S. Fuel-Flexible Gasification-Combustion Technology for Production of H2 and Sequestration-Ready CO2; Annual Technical Progress Report 2003, DOE Award No. DE-FC26-00FT40974. GE Global Research: Irvine, Calif., 2003.
“The Hydrogen Economy: Opportunities, Costs, Barriers, and R&D Needs (2004),” Carbon Emissions Associated with Current Hydrogen Production; National Academy of Engineering (NAE), Board on Energy and Environmental Systems (BEES).
Saxena, S. K. Drozd Vadym, Durygin Andriy, Synthesis of metal hydride from water. Int J. Hydrogen Energy 32 (2007) 2501-2503.
Saxena, S. K. (2003) Hydrogen production by chemically reacting species. International J. of Hydrogen Energy, 28, 49-53.
M C Boswell, J V Dickson. J Am Chem Soc 1918; 40, 1779-86.
US 2005/0163706 A1; Reichman et al.; Production of hydrogen via a base-facilitated reaction of carbon monoxide.
Ishida, M., Toida, M., Shimizu, T., Takemaka, S., and Otsuka, K. Formation of hydrogen without COₓ from carbon, water, and alkai hydroxide. Ind. Eng. Chem. Res. 2004, 43, 7204-7206.
Xu, X., Xiao, Y. and Qiao, C. System design and analysis of a direct hydrogen from coal system with CO₂ capture. Energy and Fuels 2007, 1688-1694.
Zevenhoven, R. Eloneva, S., and Teir, S. Chemical fixation of CO2 in carbonates: Routes to valuable products and long-term storage. Catalysis Today 115, 2006, 73-79.
Lin, S., Harada, M., Suzuki, Y. and Hatano, H. Hydrogen production from coal by separating carbon dioxide during gasification. Fuel 81 (2002) 2079-2085.

The references cited here are incorporated herein in their entirety, particularly as they relate to teaching the level of ordinary skill in this art and for any disclosure necessary for the commoner understanding of the subject matter of the claimed invention. It will be clear to a person of ordinary skill in the art that the above embodiments may be altered or that insubstantial changes may be made without departing from the scope of the invention. Accordingly, the scope of the invention is determined by the scope of the following claims and their equitable equivalents.

What is claimed is:

1. A process to sequester carbon from the fuel burner exhaust gases in industrial hydrogen production plants comprising the steps of:
(a) burning a mixture of an oxidant and fuel;
(b) generating flue gas and products of combustion;
(c) streaming the generated flue gas and the products of combustion into a first reactor;
(d) determining an amount of thermal energy needed from the fuel to produce hydrogen in a balanced steam-fuel-reformation reaction;
(e) adding the determined amount of fuel and water to produce hydrogen;
(f) passing all products of the reaction to a second reactor; and
(g) combining the products with sodium hydroxide to react at a low temperature to form sodium carbonate.

2. The process of claim 1, further comprising wherein the oxidant of step (a) is selected from atmospheric air or oxygen.

3. The process of claim 1, further comprising wherein the fuel of step (a) is coal.

4. The process of claim 1, further comprising wherein the fuel of step (a) is natural gas.

5. The process of claim 1, further comprising wherein the flue gas and products of combustion of step (b) is mainly carbon dioxide.

6. The process of claim 1, further comprising wherein the sodium hydroxide of step (g) is adjusted to react with components of gas comprised of sulfur dioxide, nitric oxide, or both, to form removable solids.

7. The process of claim 1, further comprising wherein the reaction of step (e) comprises a direct conversion of NaOH to Na₂CO₃.

8. The process of claim 1, further comprising wherein the reaction of step (e) further comprises reacting Na₂CO₃ with water and CO₂.

9. The process of claim 1, further comprising the step of continuously feeding fuel throughout the process.

10. The process of claim 1, further comprising the step of adding water when combining the products with sodium hydroxide to produce sodium bicarbonate.

11. The process of claim 1, further comprising: step (h) crystallizing impurities by combining such impurities with soda and then removing them.

12. The process of claim 11, further comprising wherein step (h) of recrystallizing the soda is accomplished through combination with an aqueous solution.

13. In all previous claims, the process to sequester carbon further comprising the step of selling reaction products selected from sodium carbonate, sodium bicarbonate, hydrogen, nitrogen, and combination thereof.

14. In all previous claims, the process to sequester carbon further comprising the step of selling energy produced from the combining the reaction products of step (e) with sodium hydroxide.

15. A process to sequester carbon from the fuel burner exhaust gases in industrial hydrogen production plants comprising the steps of:
(a) burning a mixture of atmospheric air or oxygen and natural gas or coal;
(b) generating flue gas and products of combustion, comprising mainly carbon dioxide;
(c) streaming the generated flue gas and the products of combustion into a first reactor;
(d) determining an amount of thermal energy needed from the fuel to produce hydrogen in a balanced steam-fuel-reformation reaction;
(e) adding the determined amount of fuel and water to produce hydrogen, comprising a direct conversion of NaOH to Na₂CO₃;
(f) passing all products of the reaction to a second reactor;
(g) combining the products with sodium hydroxide to react at a low temperature to form sodium carbonate; and
(h) crystallizing impurities by combining such impurities with soda and then removing them.

16. A system for sequestering carbon from the fuel burner exhaust gases in industrial hydrogen production plants comprising:
(a) a burner for combusting a mixture of an oxidant and fuel and generating flue gas and products of combustion;
(b) a first feeder to stream the generated flue gas and the products of combustion into a first reactor;
(c) wherein the first feeder is in communication with the burner to produce hydrogen in a balanced steam-fuel-reformation reaction;
(d) a second feeder to pass all products of the reaction to a second reactor; and
(e) wherein the second reactor is for combining the first reactor products with sodium hydroxide to form sodium carbonate.
